(19) United States
(12) Patent Application Publication
(10) Pub. No.: US 2012/0284198 A1
(43) Pub. Date: Nov. 8, 2012

(54) Systems, Methods and Computer Program Products for Identifying a Potentially Valuable Patent for Acquisition

(75) Inventor: Cheryl Milone, New York, NY (US)

(73) Assignee: ARTICLE ONE PARTNERS HOLDINGS, NEW YORK, NY (US)

(21) Appl. No.: 13/098,883

(22) Filed: May 2, 2011

(51) Int. Cl. G06Q 50/00; G06F 7/00

(52) U.S. Cl. 705/310; 707/769; 707/776; 707/E17.014

(57) ABSTRACT

Systems, methods and computer program products are provided for identifying patents of value for acquisition. Through analysis of actions by patent holders, accused infringers, competitors to patent holders, non-practicing entities and challengers of patents, patents of potential economic value can be identified. The acquisition of these patent rights can facilitate the development of a valuable patent portfolio.

### FIELD OF THE INVENTION

The present invention pertains to the field of identifying and acquiring patent assets.

### BACKGROUND OF THE INVENTION

Patent rights can be valuable assets. The owner of a patent has the ability to preclude competitors from making, using, selling or offering for sale, products or processes that embody the inventions claimed in the patent. For a patent owner that seeks to introduce a product or service, this ability to preclude competitors from entering a market space can provide the patent owner with significant advantages in trying to grow its business. The owner of a patent also has the ability to license the claimed invention and to generate royalties in exchange for the licensed right; if another party refuses to take a license and infringes the patent, the patent owner can sue for damages and in some circumstances obtain injunctive relief.

Perhaps surprising to many people, the owner of a patent has no obligation to practice the patented invention. Thus, the patent owner may be in the business of brokering or licensing patents and not in the business of offering patents or services to the public (and thus may be referred to a non-practicing entity); or the patent owner may offer products or services to the public, but not ones that fall within the scope of any of the patent claims. Furthermore, patent owners can obtain patent rights by having filed an application himself or herself, having employed the inventor(s) in whose name(s) the subject patent application was filed, or by having acquired rights to the application while it was pending or to the patent after issuance through purchase and assignment.

A number of patent owners that have acquired patents through purchase and assignment have tried to acquire relatively large patent portfolios that they can assert against infringers in order to generate licensing revenues. In order for these types of patent owners to execute a successful business model they must overcome an initial hurdle: how to identify patents of value. This task is particularly daunting given the number of patents that issue each year. According to the United States Patent Office's own statistics, in fiscal year 2009 alone it issued over 165,000 utility patents.

In order to identify patents of value, entities that wish to develop patent portfolios through purchase and acquisition could review all patents that are in force; however, this is not economically feasible. Another option would be to restrict by subject matter, the pool of patents that they would review, which may, for example, be defined consistent with the Patent Office's own classification system. However, even this strategy leaves a sizeable number of patents to be analyzed. Thus, there remains a need to develop new and more efficient methods for identifying patents of potential value.

### SUMMARY OF THE INVENTION

In various embodiments, the present invention provides systems, methods and computer program products for identifying patents of value so that interested parties can acquire those patents. Through these embodiments, a potential purchaser of a patent may more easily identify patents that may have economic value. If the interested party is able to acquire one or more of those patents, it may increase its ability to generate royalties.

According to a first embodiment, the present invention provides a method for identifying and optionally acquiring a patent. The method comprises: (a) identifying a patent dispute in which an assertion of at least one of infringement, unenforceability or invalidity of a first patent has been made; (b) identifying a second patent that satisfies at least one of the following conditions: (i) is identified on the face of the first patent; (ii) is a family member of a patent or patent application that is identified on the face of the first patent; (iii) is referenced in the file history of the first patent; (iv) is a family member of a patent or patent application that is referenced in the file history of the first patent; (v) is identified in a prior art search conducted against at least one claim of the first patent; (vi) is a family member of a patent or patent application that is identified in a prior art search conducted against at least one claim of the first patent; (vii) is cited in a document produced or generated in the patent dispute; (viii) is a family member of a patent or patent application cited in a document produced or generated in the patent dispute; (ix) is identified in a technology description of all or, a part of a claim or embodiment of the first patent or in a technology description of all or part of an alleged infringing system or method; (x) is a family member of a patent or patent application that is identified in a technology description of all or a part of a claim or embodiment of the first patent or in a technology description of all or part of an alleged infringing system or method; or (xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description; and (c) optionally, purchasing or licensing the second patent or providing information that identifies the second patent to an agent, wherein after receiving the information, the agent purchases or licenses the second patent. In some embodiments, the party that acquires the patent or on whose behalf it was acquired may be a non-practicing entity.

Each of the aforementioned criteria of (b) in paragraph [0008] may be used in a separate method, and any of two, three, four, five, six, seven, eight or nine may be used at the same time as alternate conditions that may be satisfied in a method or any subset that does not contain two or more mutually exclusive conditions, may be applied as cumulative conditions the plurality of which must be satisfied.

Step (c) is optional, and it is within the scope and spirit of the present invention to perform only steps (a) and (b). A clearinghouse or an information source business that does not wish to or does not have the assets to acquire patents may perform the aforementioned steps (a) and (b) and optionally distribute information identifying the second patent to third parties. The third parties may, for example, subscribe to a service offered by the clearinghouse or information source business and pay for the identification of a certain number of second patents or for a subscription that provides information for a fixed time period, e.g., one month, six months or one year.

According to a second embodiment, the present invention provides another method for identifying and optionally acquiring a patent. This method comprises: (a) identifying a patent dispute in which an assertion of at least one of infringement, unenforceability or invalidity of a first patent has been made; (b) identifying a second patent that satisfies at least one of the following conditions: (i) is identified on the face of the first patent; (ii) is a family member of a patent or patent application that is identified on the face of the first patent; (iii) is referenced in the file history of the first patent; (iv) is a family member of a patent or patent application that is referenced in the file history of the first patent; (v) is identified in a prior art search conducted against at least one claim of the first patent; (vi) is a family member of a patent or patent application that is identified in a prior art search conducted against at least one claim of the first patent; (vii) is cited in a document produced or generated in the patent dispute; (viii) is a family member of a patent or patent application that is cited in a document produced or generated in the patent dispute; (ix) is identified in a technology description of all or, a part of a claim or embodiment of the first patent or in a technology description of all or part of an alleged infringing system or method; (x) is a family member of a patent or patent application that is identified in a technology description of all or a part of a claim or embodiment of the first patent or in a technology description of all or part of an alleged infringing system or method; or (xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description; (c) identifying a third patent that satisfies at least one of the following conditions (i) is identified on the face of the second patent; (ii) is a family member of a patent or patent application that is identified on the face of the second patent; (iii) is referenced in the file history of the second patent; (iv) is a family member of a patent or patent application that is referenced in the file history of the second patent; or (v) has as at least one named inventor, a person who is a named author of a non-patent reference that is cited on the face of the second patent, or is referenced in the file history of the second patent; and (d) optionally, purchasing or licensing the third patent or providing information that identifies the third patent to an agent, wherein after receiving said information, the agent purchases or licenses the third patent.

Step (d) is optional, and it is within the scope and spirit of the present invention to perform only steps (a), (b) and (c). A clearinghouse or an information source business that does not wish to or does not have the assets to acquire patents may perform the aforementioned steps (a), (b) and (c) and optionally distribute information identifying the second patent to third parties. As with the previous embodiment, the third parties may subscribe to a service offered by the clearinghouse or information source business, and for example, pay for the identification of the third patent.

Additionally and similar to the previous embodiment, methods can be implemented that require the satisfaction of a specific one of the criteria of (i)-(x) of (b) and/or the satisfaction of a specific one of the criteria of (i)-(v) of (c). Furthermore, methods may be implemented that require satisfaction of any plurality of the criteria of any subset of the criteria of (i)-(xi) of (b) that are not mutually exclusive and/or any plurality of any subset of the criteria of (i)-(v) of (c) that are not mutually exclusive.

According to a third embodiment, the present invention provides a system for identifying prior art. The system may comprise an output device and a central processing unit that is operably coupled to the output device. The central processing unit may comprise a first and second computer program product. The first computer program product may comprise a set of executable instructions that when executed cause the identification of a patent dispute. The second computer program may comprise a second set of executable instructions that when executed identify a second patent. The second patent may be identified because of its relationship to the subject matter of the patent dispute. Thus, it may satisfy one of the criteria described in connection with the methods described above for identifying a second patent. The output device is capable of outputting information that identifies the second patent to a user (e.g., in hard copy or electronically through digital media such as an e-mail) or to a storage device.

### BRIEF DESCRIPTION OF THE FIGURE

FIG. 1 is a representation of an overview of the implementation of certain methods of the present invention.

### DETAILED DESCRIPTION OF THE INVENTION

According to one embodiment, the present invention provides a method for identifying a patent of value for acquisition. According to this method, there is a first step of identifying a patent dispute in which an assertion of at least one of infringement, unenforceability or invalidity of a first patent has been made. After a first patent is identified, it may be used as a lead for identifying other patents that are related to the same subject matter and are potentially of value.

A “patent dispute” is a disagreement between two parties or among more than two parties as to one or more of infringement, validity or enforceability of a patent right. Examples of patent disputes include, but are not limited to: patent litigation, an arbitration proceeding, a mediation proceeding, an opposition proceeding, a revocation proceeding and a reexamination proceeding. Typically, at least one party to the dispute is an owner, co-owner or exclusive licensee of the patent. These proceedings may take place in a court, before an administrative tribunal or in the cases of arbitration or mediation before a private third party. Additionally, a second party (a party that has a dispute with a patent owner) may in some embodiments be a person or other legal entity other than a government agency. Thus, in some embodiments a patent dispute excludes ex parte patent prosecution.

Identification of patent disputes may, for example, be accomplished by monitoring one or more of the following: court dockets, publications by or records of administrative tribunals, publications by the press, which may include one or both of print media and electronic media, periodicals, newsletters, and blogs. One method of monitoring is through regular or irregular searches of the internet, specific websites, or computer databases.

When identifying patent disputes, one may utilize one or more filters. The filters may each comprise a criterion or set of criteria that may be used to limit and/or to reduce the number of patent disputes that are selected for review and sources of potential leads for valuable assets. Filters used to narrow the field of patent disputes may be referred to as “patent dispute filters.” One example of a filter applies criteria that cause the search for a patent dispute to be in a particular forum such as a court or Patent Office. This type of filter may be referred to as a forum filter.

In order locate patent disputes, one may, for example, subscribe to a commercial or governmental service that tracks court filings such as Prior Smart or PACER® and institute an automated search of the applicable database for all new filings or only those filings for which a profile indicates that a patent litigation has been denoted. Alternatively, or additionally one may monitor European Patent Office filings in which oppositions have been initiated. Further, one may additionally or alternatively monitor the United States Patent Office's Official Gazette and/or website for notification of reexamination proceedings. When searching reexamination proceedings, one may choose to review all reexaminations or only those that are inter partes or only those that are ex parte proceedings. When reviewing ex parte proceedings, optionally one may restrict the review to proceedings that were not filed by the patent holder or that were or were not initiated on behalf of the patent holder. By focusing on disputes that involve at least one private party other than the patent holder, there is implicit recognition that the patent that is the subject of the dispute may have economic value because another party invested the resources to challenge the patent or to fight a charge of infringement.

Other patent dispute filters may restrict by jurisdiction, e.g., the United States, Canada, Europe, Australia, Japan, etc. Thus, a “jurisdictional filter” refers to the location of the dispute. (By contrast a forum filter might be litigation regardless of the jurisdiction, or it may also comprise a jurisdiction component, e.g., United States litigation.) In some embodiments, two or more jurisdictions may be combined to require that disputes were pending in a plurality of jurisdictions. In other embodiments, this filter may be designed in the disjunctive to allow for the dispute to occur in any one or more of a number of jurisdictions.

The forum and jurisdiction filters help to focus where to look for patent disputes. Other types of filters focus on narrowing the number of patent disputes that are pursued as leads for identifying patent for acquisition. For example one of these types of filters may be based on technology. This “technology filter” may be used in conjunction with or instead of the forum filter and the jurisdiction filter. A technology filter could, for example, rely on a patent classification system, such as that established by the U.S. Classification Code System or the International Classification Code System. Moreover, this filter may be set up to require one or more than one code on the face of the patent, which would further narrow the disputes examined, or require at least one of a plurality of codes. In some embodiments, it may require the presence of a specific primary classification code.

A technology filter could also rely on the use of key words. The presence of one or more key words in the patent in dispute would further restrict the number of patents within a pool to review. These key words could, for example, be based on words relevant to a particular technology and Boolean search rules could be implemented to require one or more terms to be present anywhere in the first patent or in specific fields such as the title or claims. A technology filter may take advantage of both classification systems and key words in order to limit the number of patents identified in patent disputes to which to look in order to find leads for potential patent acquisitions.

Another type of filter is a “minimum number of third parties filter.” In this type of filter, a patent dispute is subjected to further examination as a lead for identification of a patent of value only if a threshold number of third parties (e.g., accused infringers or validity challengers or combinations thereof) have been sued on the patent or have requested initiation of a challenge to the validity of the patent. This filter may be designed so as to require a cumulative number of third-parties or a simultaneous number of third parties. The requirement of a cumulative number of third parties refers to a requirement that a minimum number of parties have challenged and/or been sued under a patent, e.g., at least 2, 3, 4, 5, 6, 10, etc., but that the disputes do not necessarily need to be pending at the same time. A simultaneous number of parties filter applies a criteria that at a given time there are at least 2, 3, 4, 5, 6, 10, etc., parties who are challenging and/or being sued under a patent. These parties might be in a single dispute or they might be in a plurality of disputes.

Another type of filter is a “temporal filter.” In this filter, a user (or an operator of a system that implements the methods of the present invention) may select a time in which the dispute was filed or was resolved, e.g., within the past 10 years, 5 years, 4 years, 3 years, 2 years, 1 year, 6 months, 3 months, 2 months or 1 month. The filter may also allow the user to select a filter that looks for disputes that are still pending or that have been completed.

In some embodiments, the method involves mining a computer database. The mining may be automated and occur at regular intervals, e.g., daily, weekly, monthly, etc. Alternatively, it may occur in response to a triggering event. Examples of triggering events include but are not limited to a request received from a person who wishes to look to patent disputes as a source of information about potentially valuable patents for acquisition, or a press release, a blog or a newspaper article.

After a patent dispute is identified, and if desired, any of the aforementioned patent dispute filters have been applied, (which may be accomplished by culling for all patent disputes or e.g., all within a forum or jurisdiction and then applying other filters or alternatively applying the filter(s) during the culling stage) the specific patent or patents that are the subject of the patent dispute(s) may be identified. The identification of these patents may be accomplished by manually reviewing the relevant documents, e.g., court pleadings or Patent Office publications, or through the use of a computer program that is designed to mine databases that contain this information or to access the relevant documents through the use of optical character recognition software and search for numbers that contain the same number of digits as a standard patent and/or optionally begin with a number that is indicative of a patent that may be enforced or issued (e.g., for U.S. utility patent one may search for seven digit numbers that begin with a 6 or 7 or higher for when the USPTO starts to issue patents with numbers of 8 million or more) and/or look for a number sequence that is proximal to the word “patent” or abbreviation “Pat.” After a patent or plurality of patents is identified, either a copy of the patent(s) or the applicable bibliographic information may be sent to a user for confirmation that the user wishes to use it as a starting point for leads. Alternatively, the program may be configured to proceed automatically to the next step to identify potential patents for acquisition. A patent identified by a patent dispute filter or set of filters may be referred to as a first patent. If a plurality of patents is identified by a patent dispute filter or filters they may form a set of first patents. This set may comprise exactly or at least 1, 2, 3, 5, 10, 20, 30, 40, 50, 200, etc. patents. This first set can be determined by applying additional filters such as earliest priority date or most recent patent dispute initiation date. Alternatively or additionally, the first set of patents could be ordered by means as simple as patent number, either oldest to newest or newest to oldest.

A user may at each session or upon setting up of a user profile, select a set of “patent dispute filters” and a set of “first tier patent lead” filters for searching for a patent for further investigation for acquisition. The first tier patent lead filters help a user locate patents for acquisition based on information deemed by others (such as a litigant or a Patent Office) to be relevant to the first patent. A patent identified after application of one or more first tier patent lead filter may be referred to as a second patent. If a plurality of patents is identified by the one or more first tier patent lead filters, the patents that are identified may form a set of second patents. A user may narrow this set by applying more filters and/or substantively reviewing one or more members of the set.

The criteria that form the first tier patent lead filters may include one or more of the second patent: is identified on the face of the first patent; is a family member of a patent or patent application that is identified on the face of the first patent; is referenced in the file history of the first patent; is a family member of a patent or patent application that is referenced in the file history of the first patent; is identified in a prior art search conducted against at least one claim of the first patent; is a family member of a patent or patent application that is identified in a prior art search conducted against at least one claim of the first patent; is cited in a document produced or generated in the patent dispute; is a family member of a patent or patent application that is cited in a document produced or generated in the patent dispute; is identified in a technology description of all or, a part of a claim or embodiment of the first patent or in a technology description of all or part of an alleged infringing system or method; or has as at least one named inventor, a person who is named as an author of a non-patent reference that is cited on the face of the first patent, is referenced in the file history of the first patent, is identified in a prior art search conducted against at least one claim of the first patent or is cited in a document produced or generated in the patent dispute or identified in the technology description. The term “author” includes “co-author.” A “non-patent reference” is a publication other than an issued patent or published patent application and includes but is not limited to scientific journals, web-postings, magazines and newspapers.

The user may look to any or all of these criteria as patent lead generators. These first tier patent filters may be simultaneously applied so that satisfaction of any of the criteria will lead to a patent being identified as a second patent. In some embodiments, these patent lead generators may be automated. Thus, when a user designs the parameters of lead generation he or she may select one or more first tier patent lead generator filters. These filters may be applied in the alternative or as combined requirements. The first tier patent lead generators may also be configured to weed out any patents that are family members of the first patent. A first patent is a family member of a second patent if the first patent claims priority to the second patent, the second patent claims priority to the first patent or the first patent and second patent directly or indirectly claim priority to the same patent or patent application.

By way of a non-limiting example, a user may select a patent dispute filter of U.S. litigation, and a first tier patent lead filter of the document being an issued patent on the face of the patent that is the subject of the dispute. A further filter might require not only that it was cited on the face of the first patent, but also that it was substantively discussed in an office action, which can be determined by, for example, review of a file history of a patent, which may be performed manually or automatically by a computer.

Additional filters may be selected and applied to the second patent. These filters may, for example, include one or more of: (i) the patent is alive; (ii) the patent is not the subject of a re-examination proceeding; (iii) the patent has at least 2, 3, 4, 5, 6, 7, 8, 9, 10, 11, 12, 13 or 14 years of patent term left; (iv) foreign counterparts are pending; (v) no foreign counterparts were filed; (vi) foreign counterparts have issued far enough in the past that the opposition period in all countries or at least in Europe has expired; (vii) there are a minimum number of claims, e.g., at least 2, at least 3, least 5, at least 10, at least 20; (viii) there are a minimum number of independent claims, e.g., at least 2, at least 3, least 5; or (ix) there are issued patents that are family members of that patent. A person of ordinary skill in the art will readily recognize that (iv), (v) and (vi) are mutually exclusive.

The next step may be purchasing or licensing the second patent or providing information to an agent that identifies the second patent, wherein after receiving the information, the agent approaches the patent owner and offers to purchase or to license the second patent. In some embodiments, the method comprises acquiring title to the second patent and/or identifying a party that has standing to sue on the second patent. (In some countries, including the United States, an exclusive license has standing to sue.) After acquiring title, the party that acquires it may choose to record the transfer of rights with the appropriate governmental body so as to provide public notice of the transfer.

In some embodiments, there is an additional patent dispute filter of the assertion of infringement having been made and the case having been settled based on an infringement analysis.

According to a second embodiment, there is a method for identifying a patent for acquisition that looks to a filter that is a first tier patent lead generator and a filter that is a second tier patent lead generator. The method comprises: (a) identifying a patent dispute in which an assertion of at least one of infringement, unenforceability or invalidity of a first patent has been made; (b) identifying a second patent that satisfies at least one of the following conditions: (i) is identified on the face of the first patent; (ii) is a family member of a patent or patent application that is identified on the face of the first patent; (iii) is referenced in the file history of the first patent; (iv) is a family member of a patent or patent application that is referenced in the file history of the first patent; (v) is identified in a prior art search conducted against at least one claim of the first patent; (vi) is a family member of a patent or patent application that is identified in a prior art search conducted against at least one claim of the first patent; (vii) is cited in a document produced or generated in the patent dispute; (viii) is a family member of a patent or patent application that is cited in a document produced or generated in the patent dispute; (ix) is identified in a technology description of all or, a part of a claim or embodiment of the first patent or in a technology description of all or part of an alleged infringing system or method; (x) is a family member of a patent or patent application that is identified in a technology description of all or a part of a claim or embodiment of the first patent or in a technology description of all or part of an alleged infringing system or method; or (xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in the technology description.

As used herein, the phrase “technology description” refers to references that relate to background technology or technology that is the same subject as for example, a claim or embodiment of the invention or an allegedly infringing system. These references may or may not either alone or in combination with other references be of use in forming the basis for an opinion as to the validity of a claim.

The next step involves identifying a third patent through a filter that is a second tier patent lead generator. This filter may require that the third patent satisfies at least one of the following conditions: (i) is identified on the face of the second patent; (ii) is a family member of a patent or patent application that is identified on the face of the second patent; (iii) is referenced in the file history of the second patent; (iv) is a family member of a patent or patent application that is referenced in the file history of the second patent; or (v) has as at least one named inventor, a person who is named as an author of a non-patent reference that is cited on the face of the second patent or is referenced in the file history of the second patent.

A final step, which is optional, comprises purchasing or licensing the third patent or providing information to an agent that identifies the third patent, wherein after receiving the information, the agent purchases or licenses the third patent.

As noted, the first set of filters that are applied may be referred to as the first tier of patent lead generators, and the second set of filters that are applied may be referred to as the second tier of patent lead generators. Any of the patent dispute filters or additional patent lead filters noted above in connection with the previous embodiment may be used in connection with this embodiment.

In some embodiments, none of the first patent, second patent or third patent are family members of one another. In other embodiments, the second patent is a family member of only one of the first patent or the third patent. Thus, the third patent and the first patent are not family members of each other.

The systems, methods and computer program products of the various embodiments of the present invention may be implemented through technologies that are now known or that come to be known and that may be appreciated by persons of ordinary skill in the art as being of use in connection with the present invention. For example, the instructions for implementing the above-referenced methods may be embodied in a computer program product and carried out on hardware, software or a combination thereof that permits the development and use of systems that comprise components that are operably coupled to one another.

The various embodiments of the present invention may be performed by one or more computers that have access to networks or communication devices in order to permit them to access and to interact with the necessary information sources. Thus, in various embodiments, the methods are accomplished through the use of a computer that comprises a central processing unit and one or more input/output devices. The computer may have access to the internet or other network and may, for example, be configured to monitor new court filings and/or filings in one or more Patent Offices.

The systems, methods and computer program products may be implemented through one or more computers or central processing units that are configured to automate the methods of the present invention. The phrase “central processing unit” and the abbreviation “CPU” are used interchangeably and refer to an electronic circuit that can execute a computer program and can accomplish electronic communication through for example a processor. A processor is the part of a computer that can execute instructions and manipulate data. The phrase “computer program product” as used herein, refers to instructions that can be stored on hardware, software or a combination of both.

The system may have specific software, including a browser that standardizes communication with network servers. These servers may be any devices that are capable of receiving, delivering and sending email messages, text messages and/or other messages that are sent to it. Thus, a server may comprise a storage device, an input device, an output device, a memory device, a processor and a communication interface.

Persons who are interested in receiving information about patents of potential value may communicate with the entity (that may be referred to as a provider) or computer that implements the methods through one or more input devices, output devices, and communication interfaces. An input device is any device that may be used to input, to select and/or to manipulate information. By way of example, input devices include, but are not limited to, a keyboard, a mouse, a graphic tablet, a joystick, a light pen, a microphone, and a scanner. An output device may be any device that enables a computer to present information to a user, and includes, but is not limited to, a video display, a printer, and an audio speaker.

A communication interface is a tool for receiving input and sending output. Thus, it is or is part of a portal or is operably coupled to a portal. By way of example, communication interfaces may include but are not limited to a modem, network interface card and requisite software such as for protocol conversion and data conversion to communicate through e.g., a LAN, WAN or otherwise over the Internet. A “portal” is a method, system or apparatus for connecting to a network. For example, a portal may be a means of accessing the Internet.

The filter criteria and results from the methods of the present invention may be stored on one or more memory devices. A memory device is a device that can store, retrieve or facilitate the retrieval of data. By way of example, a memory device may comprise one or more of Random Access Memory (RAM), Read Only Memory (ROM), a magnetic drive, a Digital Video Disk (DVD) drive, or removable media storage. This information may, for example, be stored in a database.

By way of one non-limiting example, an embodiment of the present invention is directed to a system for identifying prior-art that comprises and output device, a central processing unit and optionally an input device.

The central processing unit may comprise a first computer program product and a second computer program product. The first computer program product contains a set of executable instructions, that when executed identify a patent dispute and a first patent that has been the subject of an assertion of at least one of infringement, unenforceability or invalidity with respect to the first patent. The first computer program product may be stored on software, hardware or a combination of both software and hardware. The first computer program product may be set to operate on a schedule, for example, hourly, daily, weekly, etc., and may identify a patent dispute by receiving user input (through, for example, an input device) that identifies the dispute or by activating a data mining module that, for example, mines a database of patent disputes. The mining may occur remotely, e.g., over a network.

If there are a plurality of patents that are the subject of the patent dispute, the first computer program product can identify patents of interest that are related to the subject matter of each patent that is identified in the patent dispute or apply a filter that narrows the number of patents to examine. The filter may, for example, consider the life remaining on the patent, the filing date of the patent, or the number of disputes of which it is the subject.

The second computer program product, which may be operably coupled to the first computer program product, may apply one or more criteria of any of the methods of the present invention to identify a second patent. Additionally, there may be a third computer program product that identifies a third patent by applying one or more of the criteria described in connection with the methods of the present invention for the second embodiment. Although described herein as separate computer program products, a person of ordinary skill in the art will readily recognize that they could be structured as and unless otherwise specified are equivalents to, modules of a single computer program product.

In another embodiment, the present invention provides a computer program product stored in a tangible medium. The medium may be a non-transitory tangible computer readable storage medium comprising a set of executable instructions that are capable of directing a computer to execute the necessary steps for the modules that implement the invention to perform their intended purpose or to effectuate any of the methods described herein.

A “non-transitory tangible computer readable storage medium” may also be referred to as a computer program product, and includes hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions are software stored on a medium that can instruct a computer having one or more of the following hardware components: memory, storage, an input device, an output device and a central processing unit.

Upon accessing the appropriate program, which may, for example, be accessible on a website when a user has a recognized identification name and password, the user may select one or more patent dispute filters. For example, she may select a jurisdictional filter, such as the United States, thereby indicating that she wishes the program to focus on U.S. patent disputes. She may also select a technology filter such as information technologies, and a forum filter of courts. Finally, she may select a temporal filter that the dispute was filed with the past three years.

The system may then search the appropriate databases that would identify these types of patent disputes. Next, if appropriately configured, it may search for the set of first patents identified in the patent disputes and filter out ones that are not directed to the desired technology. The system may then look for a set of second patents, which may for example be chosen because they or their family members (including publication of an application that led to issuance of a patent) are listed on any of the first patents. These patents that are identified as part of the set of second patents may then be subjected to another filter that asks whether they are alive and still have at least six years of patent term left. After this subset of patents has been identified, it may be provided to the user.

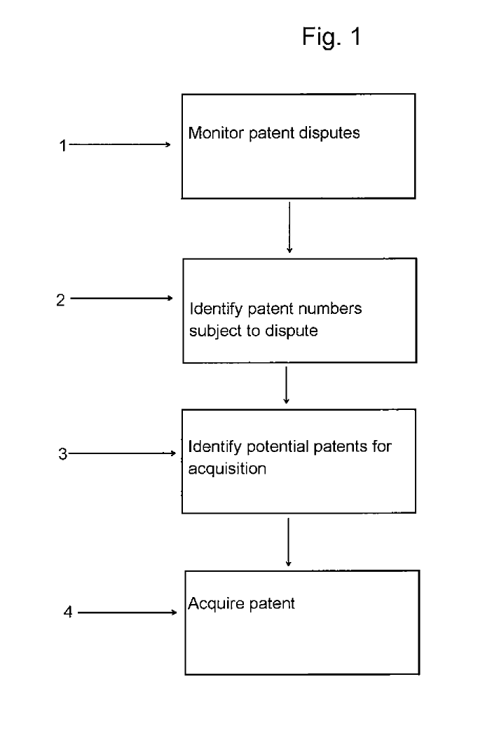

Certain embodiments of the present invention may be further understood by reference to FIG. 1. The computer program may regularly monitor patent disputes 1 by accessing a database of court filings for patent disputes and extract the information for all filings for which the case was filed within e.g., the prior three years. The computer program may then extract all initial pleadings from those cases and through OCR (Optical Character Recognition) technologies look for patent numbers. The computer program may then look for U.S. classifications that correspond to the selected technology, and generate a list of patents 2.

If no patents exist that satisfy the selected patent dispute criteria, the computer program will send a notice to the user. If any patents do exist, the computer program may provide the user with a list of patents, and optionally a copy of the patents themselves. The program may then ask the user to select which of the patents the user wishes to focus as a lead for acquisition. Alternatively, the program could provide the information described below for all patents that it identifies.

If a user selects a patent on which to focus, the computer program may then apply one or more of the first tier patent lead generators. For example, the computer program may be designed to extract all issued patent numbers including U.S. and foreign and patent publication documents (including PCT documents, U.S. Patent Publications, and foreign publications). For any foreign issued patents, U.S. Patent Publications or foreign publications, the computer program may access a commercial database such as LEXISNEXIS or Delphion to determine whether there are any U.S. issued patents that are family members or correspond to the patent application. The computer program may then generate a list of issued patents.

Based on the date and/or mining of the U.S.P.T.O. records, the computer program may then determine if, for utility patents, the requisite maintenance fees have been paid or if for other jurisdictions, annuities have been paid. For U.S. design patents, the computer program would rely on issue dates of the patents in order to determine if the patents were still alive and for most other applications consider the filing date and priority dates as appropriate. The program could also search for other information, such as if the second patent were the subject of a court proceeding, an opposition proceedings or a reexamination proceedings or has been dedicated to the public or deemed in whole or in part to be invalid. The step could be used to filter out expired patents. The cut-off date could be adjusted by, for example, up to six years after a patent expires.

After this list of patents has been generated, the computer program may send the list to a user, which identifies potential patents for acquisition 3. Optionally, the computer program can send text or pdf copies of the patents on the list to the user. The user may then approach an owner of a patent, who may be identified in the U.S. PTO assignment database, or other databases (if not on the face of the patent itself) and offer and acquire the patent 4.

One should note that the outcome of the patent dispute does not determine the value of a second patent. The second patent is of potential value because it was identified by either the patent applicant or a Patent Office as being relevant to a patented technology that was the subject of a patent dispute. Because of the transactional costs of patent disputes, one can infer that the technology that is the subject of it is likely to be of economic value. Accordingly, the patents that are the subject of the dispute are good leads for other patents of value.

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

1. A method for identifying a patent of potential value, said method comprising:
(a) identifying a patent dispute in which an assertion of at least one of infringement, unenforceability or invalidity of a first patent has been made; and
(b) identifying a second patent that satisfies at least one of the following conditions:
(i) is identified on the face of said first patent;
(ii) is a family member of a patent or patent application that is identified on the face of said first patent;
(iii) is referenced in the file history of said first patent;
(iv) is a family member of a patent or patent application that is referenced in the file history of said first patent;
(v) is identified in a prior art search conducted against at least one claim of said first patent;
(vi) is a family member of a patent or patent application that is identified in a prior art search conducted against at least one claim of said first patent;
(vii) is cited in a document produced or generated in said patent dispute;
(viii) is a family member of a patent or patent application that is cited in a document produced or generated in said patent dispute; or
(ix) is identified in a technology description of all or a part of a claim or embodiment of the first patent or in a technology description of all or part of an alleged infringing system or method;
(x) is a family member of a patent or patent application that is identified in a technology description of all or a part of a claim or embodiment of the first patent or in a technology description of all or part of an alleged infringing system or method; or
(xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description.

2. The method of claim 1, further comprising purchasing or licensing said second patent or providing information that identifies said second patent to an agent, wherein after receiving said information, said agent purchases or licenses said second patent.

3. The method of claim 1, wherein the patent dispute is a court proceeding, an opposition proceeding or a reexamination proceeding.

4. The method of claim 2, wherein said identifying comprises mining a computer database.

5. The method of claim 1 further comprising acquiring title to said second patent.

6. The method of claim 1 further comprising identifying a party that has standing to sue on said second patent.

7. The method of claim 1, wherein said second patent is identified on the face of said first patent or is a family member of a patent or patent application that is identified on the face of the first patent.

8. The method of claim 1, wherein said second patent is referenced in the file history of said first patent or is a family member of a patent or patent application that is referenced in the file history of said first patent.

9. The method of claim 1, wherein said second patent is identified in a prior art search conducted against at least one claim of said first patent or is a family member of a patent or patent application that is identified in a prior art search conducted against at least one claim of said first patent.

10. The method of claim 1, wherein said second patent is cited in a document produced or generated in said litigation or is a family member of a patent or patent application that is cited in a document produced or generated in said litigation.

11. The method of claim 1, wherein said assertion of infringement has been made and the case has been settled based on an infringement analysis.

12. The method of claim 1, wherein said second patent has as at least one named inventor, a person who is named as an author of a non-patent reference that is cited on the face of the first patent, is referenced in the file history of the first patent, is identified in a prior art search conducted against at least one claim of said first patent, is cited in a document that was produced or generated in said patent dispute, is identified in said technology description.

13. The method of claim 1, wherein the first patent is not a family member of the second patent.

14. A method for identifying a patent of potential value said method comprising:
(a) identifying a patent dispute in which an assertion of at least one of infringement, unenforceability or invalidity of a first patent has been made; and
(b) identifying a second patent that satisfies at least one of the following conditions:
(i) is identified on the face of said first patent;
(ii) is a family member of a patent or patent application that is identified on the face of said first patent;
(iii) is referenced in the file history of said first patent;
(iv) is a family member of a patent or patent application that is referenced in the file history of said first patent;
(v) is identified in a prior art search conducted against at least one claim of said first patent;
(vi) is a family member of a patent or patent application that is identified in a prior art search conducted against at least one claim of said first patent;
(vii) is cited in a document produced or generated in said litigation;
(viii) is a family member of a patent or patent application that is cited in a document produced or generated in said litigation;
(ix) is identified in a technology description of all or, a part of a claim or embodiment of the first patent or in a technology description of all or part of an alleged infringing system or method;
(x) is a family member of a patent or patent application that is identified in a technology description of all or a part of a claim or embodiment of the first patent or in a technology description of all or part of an alleged infringing system or method; or
(xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description; and
(c) identifying a third patent that satisfies at least one of the following conditions:
(i) is identified on the face of said second patent;
(ii) is a family member of a patent or patent application that is identified on the face of the second patent;
(iii) is referenced in the file history of said second patent;
(iv) is a family member of a patent or patent application that is referenced in the file history of said second patent;
(v) has as at least one named inventor, a person who is named as an author of a non-patent reference that is cited on the face of the second patent or is referenced in the file history of the second patent.

15. The method of claim 14, further comprising purchasing or licensing said third patent or providing information to an agent that identifies said third patent, wherein after receiving said information, said agent purchases or licenses said third patent.

16. The method of claim 15 wherein the third patent is not a family member of the first patent.

17. The method of claim 16, wherein the first patent is not a family member of the second patent.

18. A system for identifying prior art comprising an output device and a central processing unit operably couple to the output device, wherein the central processing unit comprises:
(a) a first computer program product, wherein the first computer program product comprises a set of executable instructions that are capable of identifying a first patent, wherein the first patent is the subject of a patent dispute; and
(b) a second computer program product, wherein the second computer program product comprises a set of executable instructions that are capable of identifying a second patent, wherein the second patent:
(i) is identified on the face of said first patent;
(ii) is a family member of a patent or patent application that is identified on the face of said first patent;
(iii) is referenced in the file history of said first patent;
(iv) is a family member of a patent or patent application that is referenced in the file history of said first patent;
(v) is identified in a prior art search conducted against at least one claim of said first patent;
(vi) is a family member of a patent or patent application that is identified in a prior art search conducted against at least one claim of said first patent;
(vii) is cited in a document produced or generated in said patent dispute;
(viii) is a family member of a patent or patent application that is cited in a document produced or generated in said patent dispute;
(ix) is identified in a technology description of all or, a part of a claim or embodiment of the first patent or a technology description of all or part of an alleged infringing system or method;
(x) is a family member of a patent or patent application that is identified in a technology description of all or a part of a claim or embodiment of the first patent or in a technology description of all or part of an alleged infringing system or method; or
(xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description.

19. The system of claim 18, further comprising a third computer program product that is capable of identifying a third patent, wherein the third patent:
(i) is identified on the face of said second patent;
(ii) is a family member of a patent or patent application that is identified on the face of the second patent;
(iii) is referenced in the file history of said second patent;
(iv) is a family member of a patent or patent application that is referenced in the file history of said second patent;
(v) has as at least one named inventor, a person who is named as an author of a non-patent reference that is cited on the face of the second patent or is referenced in the file history of the second patent.

20. The system of claim 18, wherein the first computer program product comprises a data mining module, wherein the data mining module is operably coupled to a network and capable of searching a database remote from said system whereby said searching results in identification of said first patent.
